(19) United States
(12) Patent Application Publication
(10) Pub. No.: US 2009/0308326 A1
(43) Pub. Date: Dec. 17, 2009

(54) High-Pressure Device And Method For The Production And Operation Thereof

(76) Inventors: Heiko Zimmermann, St. Ingbert (DE); Gunter R. Fuhr, Berlin (DE)

Correspondence Address: Erickson Law Group, PC, 1749 S. NAPERVILLE ROAD, SUITE 202, WHEATON, IL, 60189, US

(21) Appl. No.: 12/439,536

(22) PCT Filed: Aug. 29, 2007
(86) PCT No.: PCT/EP07/07550

§ 371 Date: Jul. 8, 2009

(30) Foreign Application Priority Data
Sep. 1, 2006 (DE) 10 2006 041 063.7
Jun. 15, 2007 (DE) 10 2007 027 643.7

(51) Int. Cl. A01K 63/00; E21D 7/00; E04H 3/10

(52) U.S. Cl. 119/247; 119/245; 52/169.7; 52/741.12

(57) ABSTRACT

The invention relates to an aquarium with a water tank (2), filled with water (3) when in operation and containing objects for investigation (4, 19), in particularly biological organisms, said water tank (2) being at least partly located below ground in the earth (5). According to the invention, the water tank (2) runs so deep into the earth (5) that, at least the bottom of the water tank (2) is at the pressure of the deep sea. The invention further relates to a corresponding method of operation.

The invention relates to a high-pressure device for the production of a hydrostatic pressure, in particular a water pressure, as found in the deep sea, and particularly a continental deep sea aquarium. The invention also relates to a method for the production and operation of such a high-pressure device.

The deep sea (the ocean region with a depth of more than 300 m, in particular more than 500 m) is one of the least investigated regions of the earth. At a depth of more than 300 m, exploration becomes difficult, since this depth cannot be reached by humans in simple diving suits and with gas bottles, or only for short periods of time and it is barely illuminated by daylight. However, the oceans have a significantly greater depth, at an average of around 3000 m. In order to penetrate the deep sea, pressure-resistant diving vehicles are therefore necessary.

The use of diving vehicles is limited to brief observation, for example, of deep sea organisms, photography and the taking of small samples. However, it has not previously been possible to investigate continuously, much less cultivate, deep sea organisms in their natural living conditions. Previously, practically no higher organisms from the deep sea have been successfully transferred alive to an environment with a lower, particularly atmospheric, pressure since the organisms have not been able to adapt sufficiently well to sea conditions close to the surface. It can also be assumed that biological macromolecules have different optimum conformation conditions at depths of greater than 8000 m than at surface water pressure, so that, for physiological reasons, fundamental adaptation and survival difficulties exist for deep sea organisms.

A systematic investigation of biological life in the deep oceans cannot be achieved without continuous observation and cultivation or preservation alive. Formerly, knowledge of life in the deep ocean has been limited because no marine laboratory which was able to provide the conditions of life in the deep sea on a large scale has been available. This is an unsolved problem and is also a precondition for a detailed study of deep sea organisms.

The installation of a laboratory in a sufficiently deep region of the free ocean has not previously been achieved because of practical problems. A laboratory would have to be constructed (e.g. assembled) starting from the surface, which would require the use of special ships and would be extremely costly. Weight and stability also present significant problems with increasing depth. Access would also present a problem, since the water column would have to be accessed via a technical accessway or by means of a transport vehicle (submarine). For access, the system would have to be emptied of water after assembly or introduced into the depths already filled with air. Later corrections, extensions and installations would be technically extremely complex. The system would be weather-dependent and could not be operated with any reliable constancy of location without a floating platform. Finally, it would be necessary to use regions of the deep sea, i.e. a logistically favourable operation close to the coast would be possible only in very few, geologically favourable cases.

It is known from actual practice that in, for example a zoo, an aquarium in which plants, fish and other organisms live in a water tank is sometimes designated a deep sea aquarium. However, this designation serves only for publicity purposes. The water tank typically has a depth of only approximately 20 m and is therefore unsuitable for reproducing the living conditions of the real deep sea.

The production of high pressures such as those which prevail in the deep sea is of interest not only for biological investigations, but also for non-biological processes, for example, for materials testing.

It is an object of the invention to provide an improved high-pressure device for the production of a high hydrostatic pressure with which the problems of the prior art can be solved. It is a further object of the invention to provide improved methods for the production and operation of a high-pressure device of this type.

These problems are solved with a high-pressure device, a high pressure shaft, in particular a mine shaft and a method having the features of the independent claims. Advantageous embodiments and applications of the invention are contained in the dependent claims.

According to a first aspect, the problem is solved with a high-pressure device which comprises at least one shaft in the earth's solid crust, and a stable pressure unit in the at least one shaft. Advantageously, the shaft is provided as a stable container which is configured to accommodate at least one water column. The depth of the shaft and thus the length of the water column which can be formed in the shaft can be selected so that conditions, in particular the pressure and illumination conditions, such as those which prevail in the deep sea can be produced in the shaft. The pressure unit (or normal pressure unit) which can be arranged either fixed or movable in the shaft, has an inner pressure chamber which is resistant to an external ambient hydrostatic pressure. The inner pressure chamber has at least one free, gas-filled hollow chamber. The pressure unit is particularly configured so that the inner pressure chamber which has an atmospheric internal pressure is resistant to an external ambient hydrostatic pressure of at least 100 bar. Advantageously, the pressure unit enables access, for example, for observation or manipulation purposes, to all the interesting regions of the shaft and the setting of environmental conditions, such as the temperature, the illumination, the salt content and the flow conditions in the shaft.

The aforementioned problems, which have previously prevented the installation of a laboratory in a sufficiently deep region of the free ocean, can advantageously be solved with the combination of the shaft in the earth's crust and the pressure unit. For example, the pressure unit can be installed without difficulty from the surface of the earth's crust in an otherwise empty shaft or can be variably converted in the emptied shaft. The pressure unit can also be stably supported on and, in particular, fastened to an inner wall of the shaft, even at great depths. The system is not weather-dependent and can be operated in a fixed location in the continental region of a landmass. The shaft can be associated, in particular, with cities, other research facilities, transport routes, etc., in a logistically optimised manner.

The term “shaft” should be understood in this context to mean an underground mine structure in general, whose longitudinal direction extends in a direction which deviates from the horizontal, in particular, in the vertical direction or a direction which is oblique relative to the vertical direction, through at least one geological formation in the earth's solid crust. According to the invention, a shaft open to the surface or a blind shaft, which only runs underground, can be provided. The shaft can be constructed using methods that are known from mining. The shaft preferably has a shaft cross-section having a round, particularly circular, form. Alternatively, an angular form can be provided.

According to an embodiment of the high-pressure device according to the invention which is preferred for practical applications, at least one water column is arranged in the shaft. The shaft or a longitudinal shaft compartment extending along the length of the shaft is filled with water. The desired hydrostatic pressure at a pre-determined depth position in the shaft is determined by the length of the water column above that depth position. The pressure can be estimated, for example, using the equation p [atm]=(depth[m]/10 m)*1 atm.

According to a particularly preferred embodiment of the high-pressure device according to the invention, the at least one shaft is a mine shaft. Advantageously, one or more shafts of shut-down mines (e.g. coal or ore mines) can be extended and converted in order to accommodate the pressure unit and to be flooded in parts and thereby to produce a shaft-formed continental deep-sea aquarium. An important advantage arises therefrom that the pressure-resistant and technical structures can be installed in the dry condition and from the surface or any other depth position in the shaft in existing mine facilities.

Preferably, a main shaft which was used in the mine for brining mine workers in and out, for hoisting, and for introducing and removing air and for removing pit water is utilised. Alternatively or additionally, an auxiliary shaft, such as a hoisting shaft or air shaft can be used.

By way of example, shafts of existing mines the diameter of which lie within the range of 6 m to 10 m and which reach a depth of more than 2000 m are available. Most of these mines are actively kept water-free during their conventional extraction operation so that flooding advantageously takes place virtually automatically after the completed installation of the pressure unit and any other components and can only be influenced with regard to the formation of marine deep water areas.

If the high-pressure device is configured, according to another preferred embodiment of the invention, with a transport device, this may bring advantages for the functioning of the high-pressure device and access to various depth positions in the shaft. The transport device is configured for transporting transported items in the shaft. The transported items usually consists of technical components, such as measuring devices, or persons who travel into the high-pressure device, for example, for the purpose of operation or observation. For the transporting of persons, the transport device is preferably arranged in the pressure unit. For this purpose, the pressure unit can alternatively be provided as part of the transport unit. According to another variant of the invention, the transport device can be arranged outside the pressure unit in the shaft, which is advantageous, in particular, for the transporting of pressure-resistant transported items in the filled shaft.

The transport device preferably comprises a lift, for example, a cable lift or a rotating “paternoster” lift. The use of a lift has the advantage that, for example, persons or technical equipment can be transported in the shaft between two or more levels in a moving cabin, a lift cage or on a platform. The movable part is guided, for example, on vertically extending rails. In the case of a paternoster lift, a plurality of individual cabins hanging, for example, on a chain run in continuous or discontinuous rotary operation.

The design of the transport device can be chosen depending on the actual application of the high-pressure device and, in particular, on the expected volume of public traffic. For scientific purposes, a lift system such as that known from mines is preferable. The lift system comprises, for example, one or more cabins with the largest possible capacity and a high load-carrying ability which travel to discrete platforms from where further descent or ascent into laboratory areas in the pressure unit is possible. In the event of heavy public traffic, a gondola or paternoster system is preferable. This may involve a cable or other transport system (chain, belt, etc.), as known from mountain lifts. Securely fastened in this manner, the gondolas are coupled and uncoupled so that persons can board and leave the gondola unhurriedly. The number of gondolas and their size can be varied.

If the high-pressure device is equipped, according to another preferred embodiment of the invention, with a pumping unit, this can produce advantages for the specific feeding in or out of water in the shaft, independently of any water ingress from the earth's crust. The filling level in the shaft can be adjusted by means of the pumping unit.

According to a further variant of the invention, the high-pressure device is equipped with a heat-exchanger unit with which an exchange of heat takes place between a liquid in the shaft or a wall of the shaft, on the one hand, and the earth's surface, on the other hand, in particular heat transport and the transfer of heat energy from the shaft to a cooler at the earth's surface. Advantageously, the high-pressure device can thereby be used for obtaining energy for its own operation or for use elsewhere.

According to a particularly preferred embodiment of the invention, the pressure unit has an internal construction. With the internal construction, the wall of the pressure unit can also advantageously be additionally stabilised against an external ambient pressure. Furthermore, the internal construction enables additional functions of the pressure unit which simplify operation of the high-pressure device. For this purpose, the internal construction has assemblies comprising at least one room for accommodating persons, at least one staircase and/or at least one transfer chamber. The provision of rooms enables access to laboratory areas that are not filled with water in the pressure unit at normal pressure or at least without complex decompression procedures. The transfer chamber advantageously enables pressure transfer and accommodation of living organisms in the at least one water column of the high-pressure device.

If, according to a further preferred embodiment of the invention, the high-pressure device is equipped with a protection unit, there are advantages for accident prevention in the high-pressure device. The protection unit is configured to reduce the hydrostatic pressure in the shaft abruptly if required. For this purpose, the protection unit preferably has at least one auxiliary shaft which is configured for accommodating water from the shaft and is separated from the shaft by means of a closure unit (e.g. a flood gate). In the event of an accident, the closure unit can be opened in order to connect the shaft to the initially empty auxiliary shaft. The closure unit may, for example, be arranged on the base or in a lower partial region of the shaft, which is configured to accommodate the at least one water column.

According to a first variant, the auxiliary shaft extends as a shaft extension beneath the base of the shaft to a greater depth within the earth's crust. Alternatively or additionally, one or more auxiliary shafts which extend parallel to the shaft and, on opening of the closure unit, receive the water from the shaft by pressure equalisation in the manner of connected vessels can be provided.

A further important advantage of the high-pressure device according to the invention lies in the great variability of the design of the pressure unit. The high-pressure device can therefore be optimally adapted to a variety of tasks and applications. According to a first variant, at least one shaft chamber, which is firmly installed in the shaft and preferably extends along a length of the shaft, can be provided. According to a second or additional variant, at least one pressure capsule, which is movably arranged in the shaft, can be provided. The pressure capsule can be freely mobile in the shaft in the manner of a submarine or can be movable exclusively along particular paths by means of a guiding device, for example, rails.

If, according to a preferred embodiment, the at least one shaft chamber has a cylinder or hollow cylindrical form, this may result in advantages for the optimum utilisation of space in the inner pressure chamber of the shaft chamber, together with all-round pressure-resistance. Particularly preferable is a configuration of the shaft chamber as a stack of hollow segments. The hollow segments enable a modular, prefabricated assembly of the shaft chamber. If the hollow segments are fixed with wall anchors in a wall of the shaft, anchorings and stiffenings against one or more shaft walls advantageously result.

According to the invention, the at least one shaft chamber can be surrounded by the at least one water column, that is, the shaft chamber extends as a chamber with reduced pressure in the flooded shaft. In this case, the shaft walls and the drifts adjacent to the shaft can advantageously be used to simulate ocean floor formations. Alternatively, the at least one shaft chamber can enclose the at least one water column on all sides.

If, according to a further preferred embodiment of the invention, the at least one shaft chamber comprises a wall made from an at least partially transparent material, for example, glass or plastics, this results in advantages for observation, image recording and/or illumination in the flooded region of the high-pressure device. Preferably, the wall of the shaft chamber comprises at least one window.

According to a further aspect of the invention, the aforementioned problem is solved with a method for production of the high-pressure device according to the invention, wherein initially the shaft in the at least one geological formation of the earth's crust is provided in a state empty of liquid and the pressure unit is installed in the empty shaft, wherein the shaft is subsequently flooded. Alternatively, the pressure unit can be installed in the already flooded shaft and then pumped empty.

According to a further aspect of the invention, the aforementioned problem is solved by means of a method for operation of a high-pressure device comprising a shaft which contains at least one water column, wherein the animal or plant organisms are kept alive in the at least one water column and are possibly cultivated. Advantageously, all the flora and/or fauna of the deep sea regions can be kept in the water column, for example, algae, plankton, bacteria, flagellates, crabs, shrimps, tubeworms, mussels, crustaceans, jellyfish, snails, sea anemones, other coelenterates, and fish.

Preferably, visual and/or camera-supported observation of the organisms in the at least one water column is provided for. The observation has the advantage that the deep sea organisms can be recorded and used for experiments without the deep sea organisms leaving the observation region and escaping to an unbounded region like in the real deep sea. Particularly preferable is a variant of the invention wherein the observation takes place from a pressure unit arranged in the shaft and having an inner pressure chamber which is resistant to overpressure in the water column.

An advantageous embodiment of the method for operating the high-pressure device is characterised by pressure-relief in the water column in the shaft, wherein actuation of a protection unit causes the free flowing away of the water under the pressure of the water column. It is preferably provided for the flowing away of the water into at least one auxiliary shaft.

In order to simulate deep sea conditions, according to the invention it is not essential for a pressure unit to be provided in the shaft. Organisms can also be kept, in particular cultivated, observed and/or manipulated, in the water column without the pressure unit, for example, by means of compact diving devices. According to a further aspect of the invention, the aforementioned problem is therefore generally solved by means of a high-pressure shaft, in particular, a mine shaft in the earth's crust which contains at least one water column formed by salt water. The water column extending into the depth of the high-pressure shaft advantageously enables sea water conditions which approach as closely as possible to those in the real deep sea to be created.

A salt water column can be constructed in that salts (in particular containing the main constituents sodium chloride, magnesium chloride, magnesium sulphate, calcium sulphate and or potassium sulphate) are added to fresh water such that the conditions of sea water are created. The water column preferably has a salt content which is greater than 20% and in particular greater than 30%. Alternatively, a salt water column can be formed by feeding sea water directly into the high-pressure shaft.

The present invention has the following further advantages. The high-pressure device enables good observation capability and complete accessibility by humans to all regions in the flooded shaft, as well as seamless recording of many depth regions, good geographical connection and accessibility to humans and technical equipment, together with long-term stable operation and independence from weather conditions and climatic influences. The high-pressure device is characterised by its great ease of servicing and the possibility of varying environmental conditions, such as the temperature or sea water parameters. Advantageously, there are no time limitations on the accommodation of persons in the pressure unit. A high level of security against destruction and the close proximity of normal pressure (accessible) regions and high-pressure deep sea water regions are also possible.

The high-pressure device provides a laboratory which, apart from the marine biological application, is usable for technical developments which could previously only be carried out in spatially limited pressure chambers.

Further details and advantages of the invention will now be described, making reference to the drawings, in which:

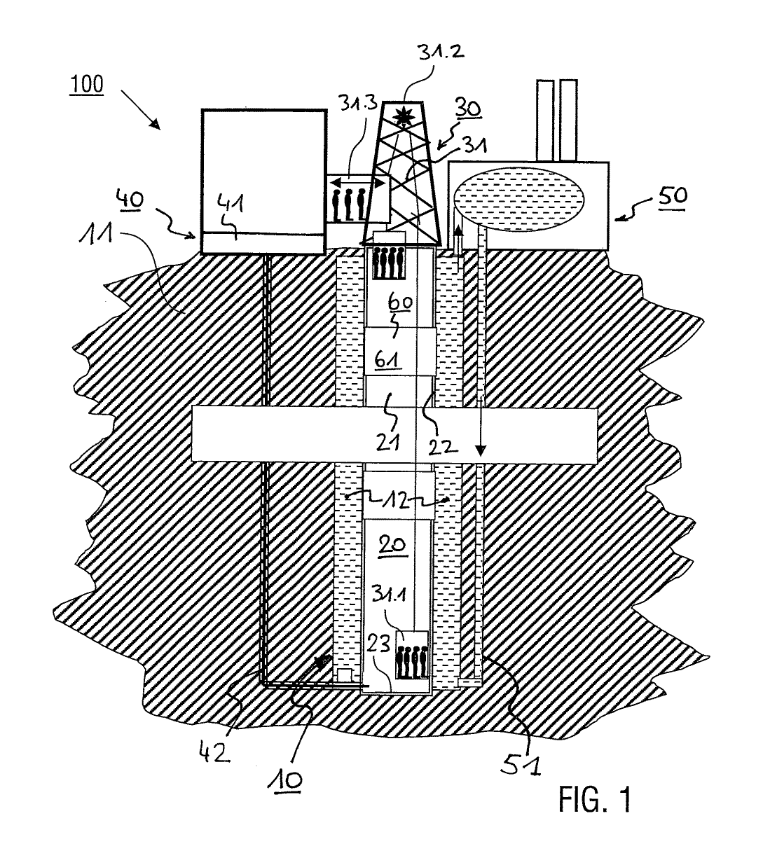

FIGS. 1 to 3 show schematic depth sectional views of different embodiments of the high-pressure device according to the invention;

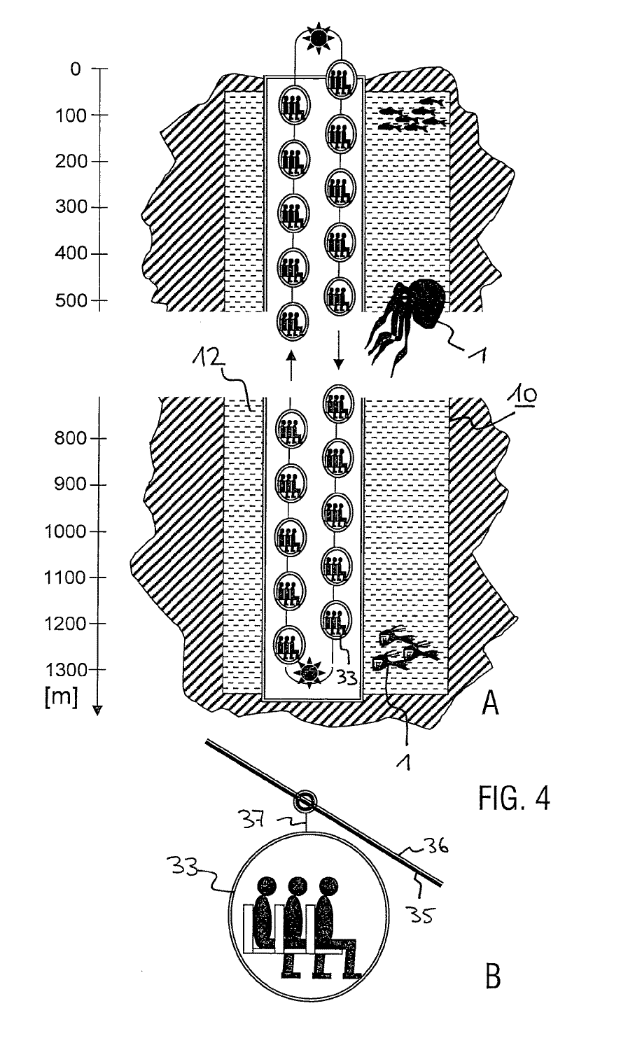

FIGS. 4A and 4B show details of a transport device used according to the invention;

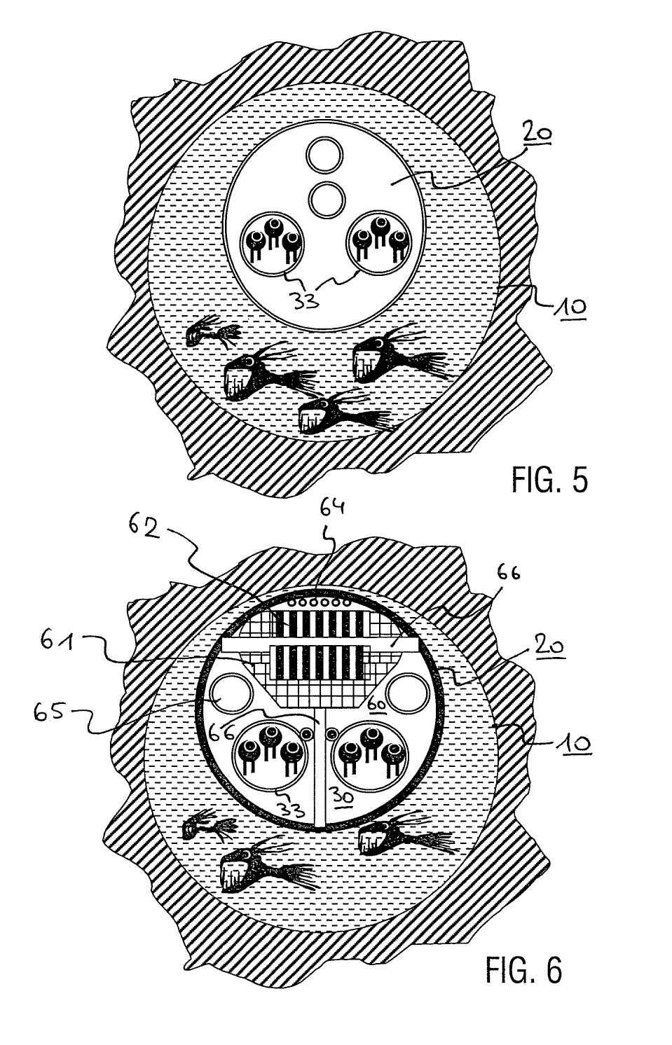

FIGS. 5 and 6 show schematic transverse sectional views of further embodiments of the high-pressure device according to the invention;

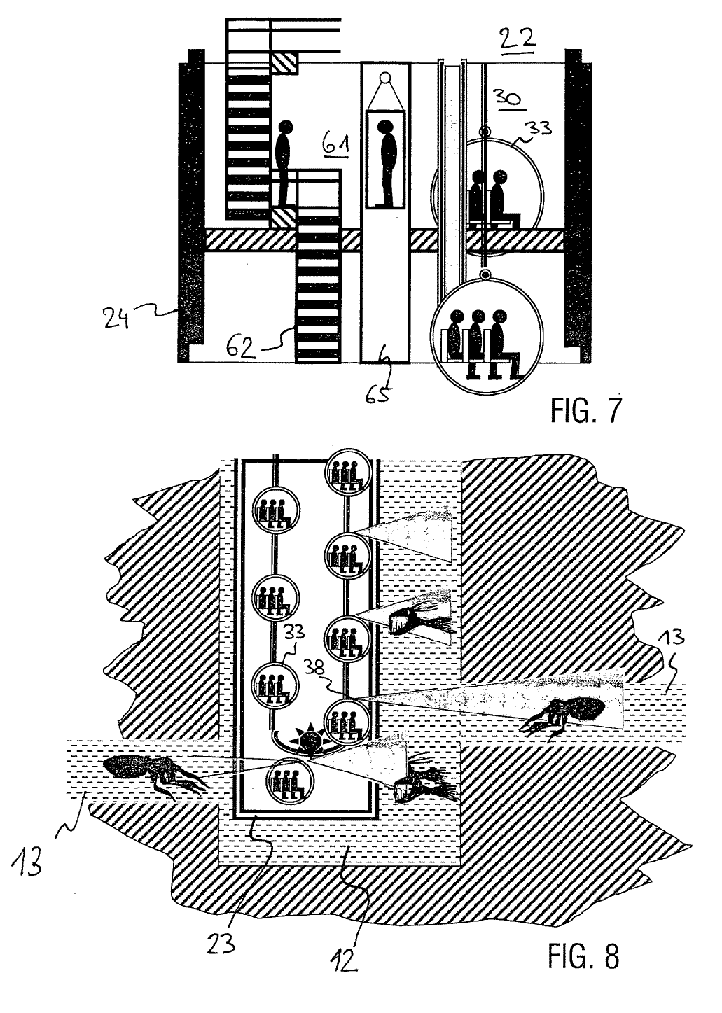

FIG. 7 shows further details of the internal design of the pressure unit used according to the invention;

FIG. 8 shows further details of the operation of the high-pressure device according to the invention;

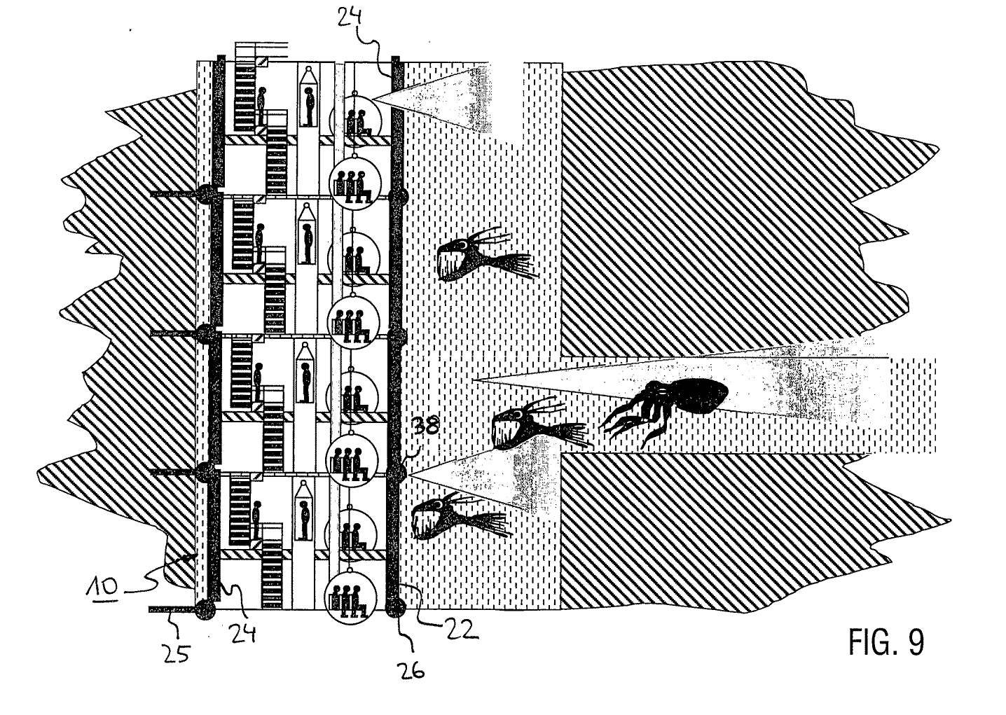

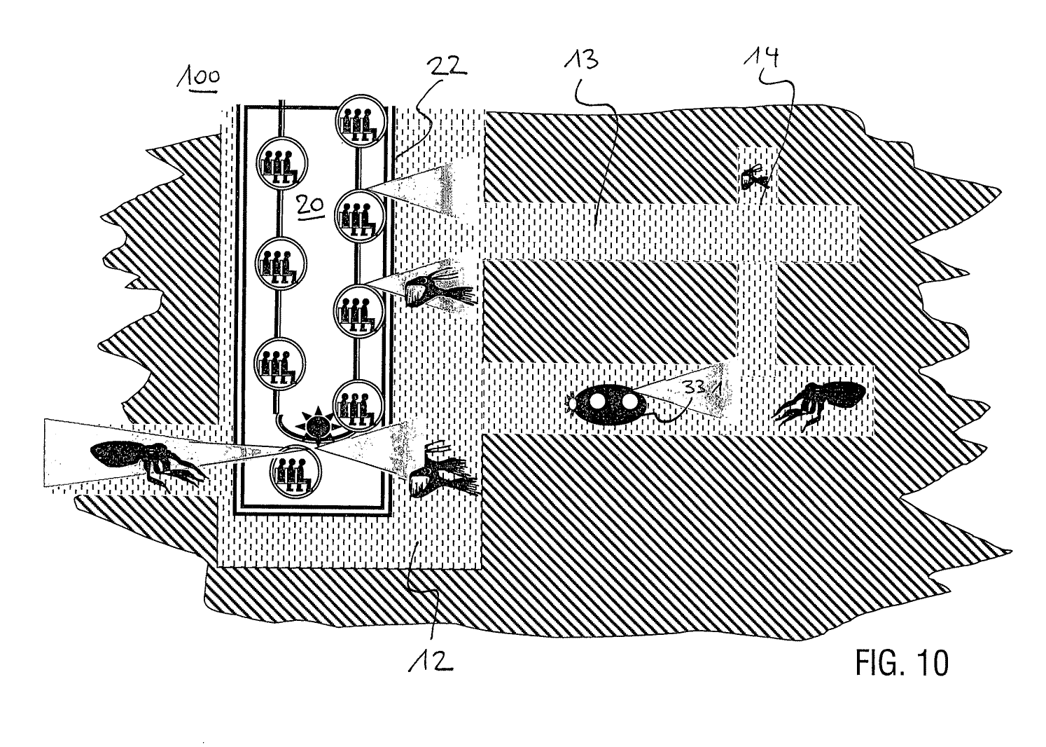

FIGS. 9 and 10 show schematic depth sectional views of further embodiments of the high-pressure device according to the invention;

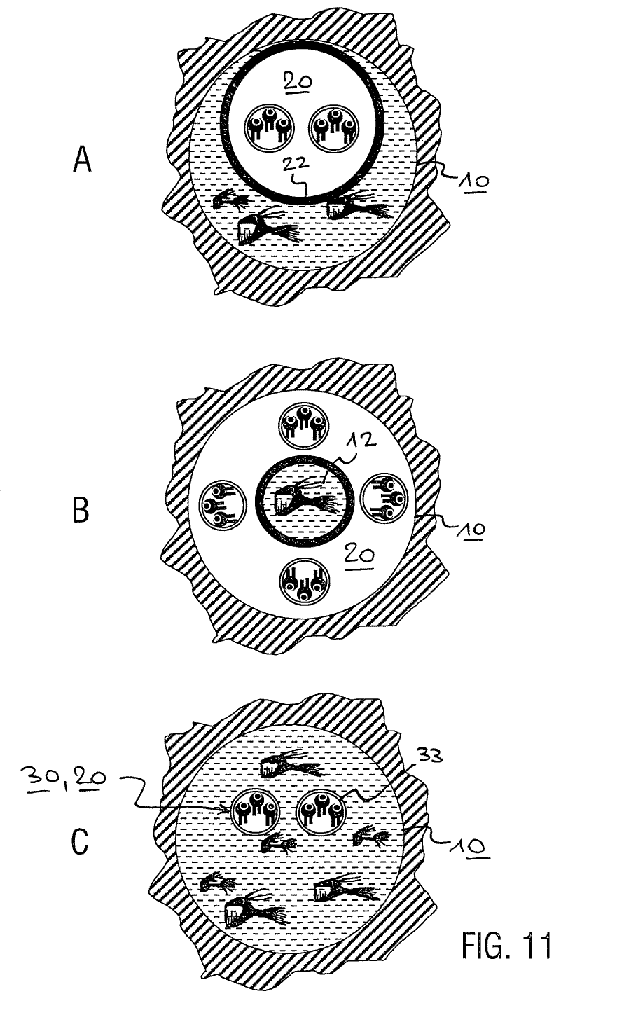

FIGS. 11A to 11C show schematic cross-sectional views of further embodiments of the high-pressure device according to the invention;

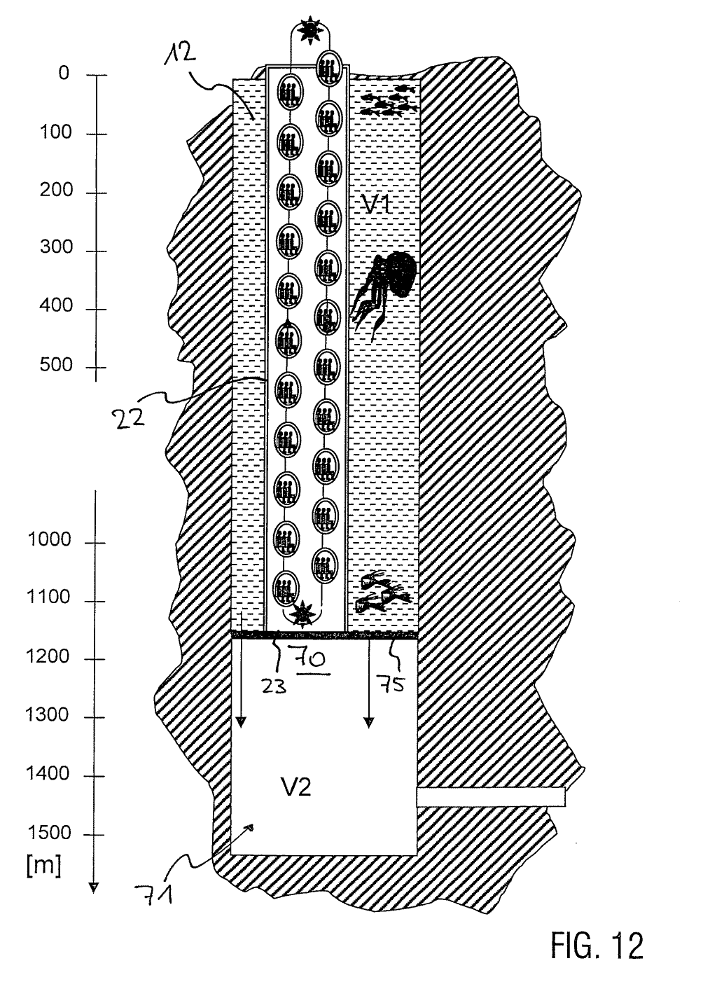

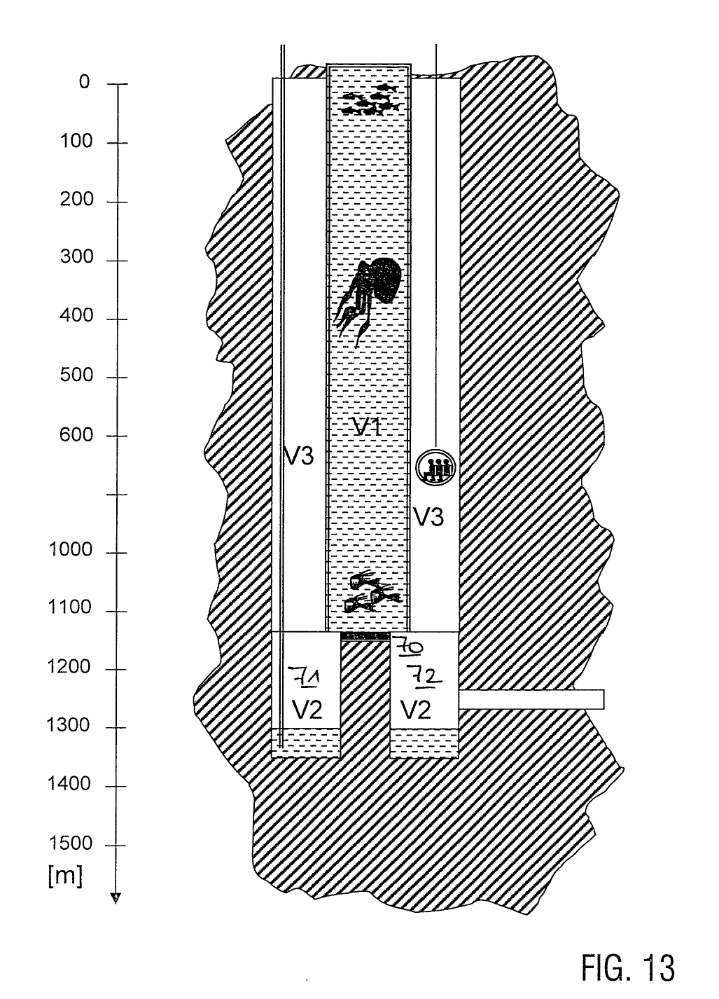

FIGS. 12 and 13: show schematic depth sectional views of protection units used according to the invention;

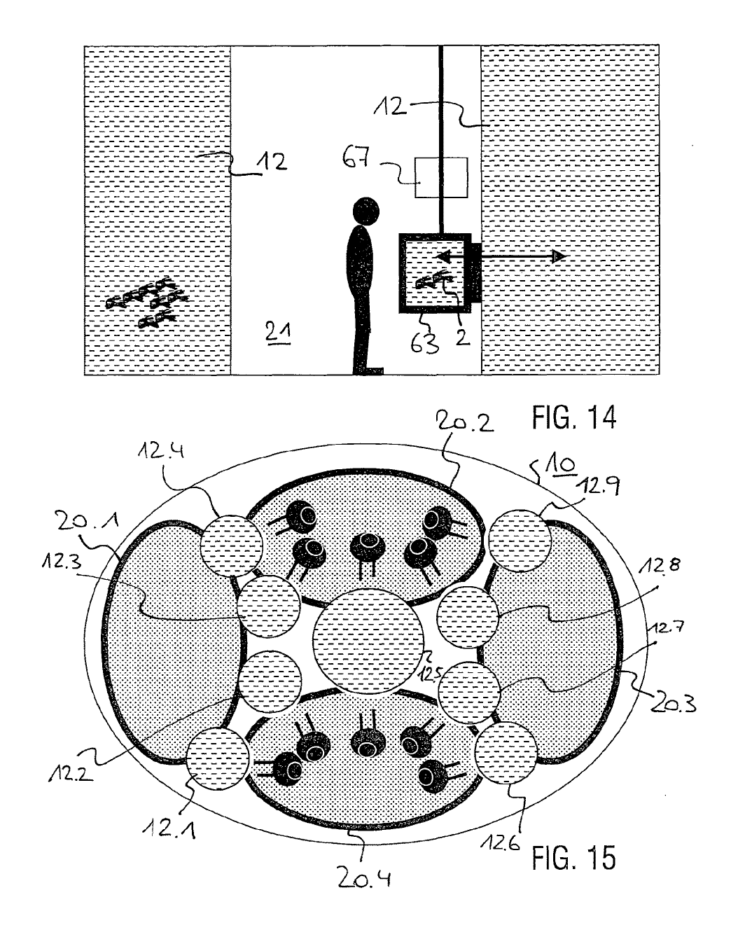

FIG. 14 shows a schematic representation of a transfer chamber unit used according to the invention;

FIG. 15 shows a schematic cross-sectional view of a further embodiment of the high-pressure device according to the invention;

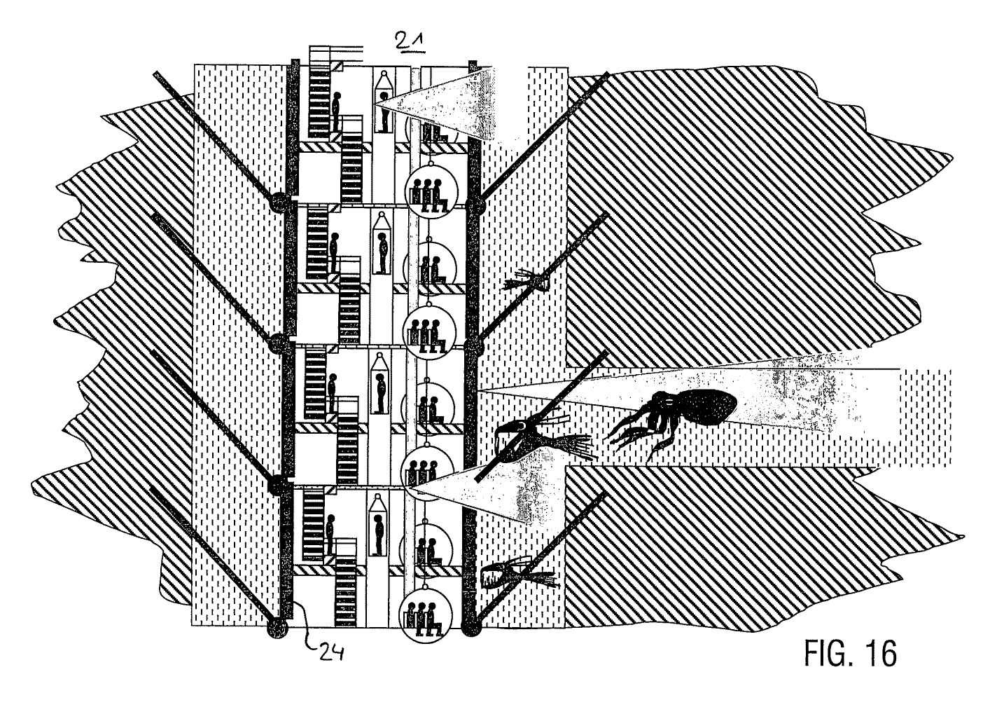

FIG. 16 shows a schematic depth sectional view of a further embodiment of the high-pressure device according to the invention; and

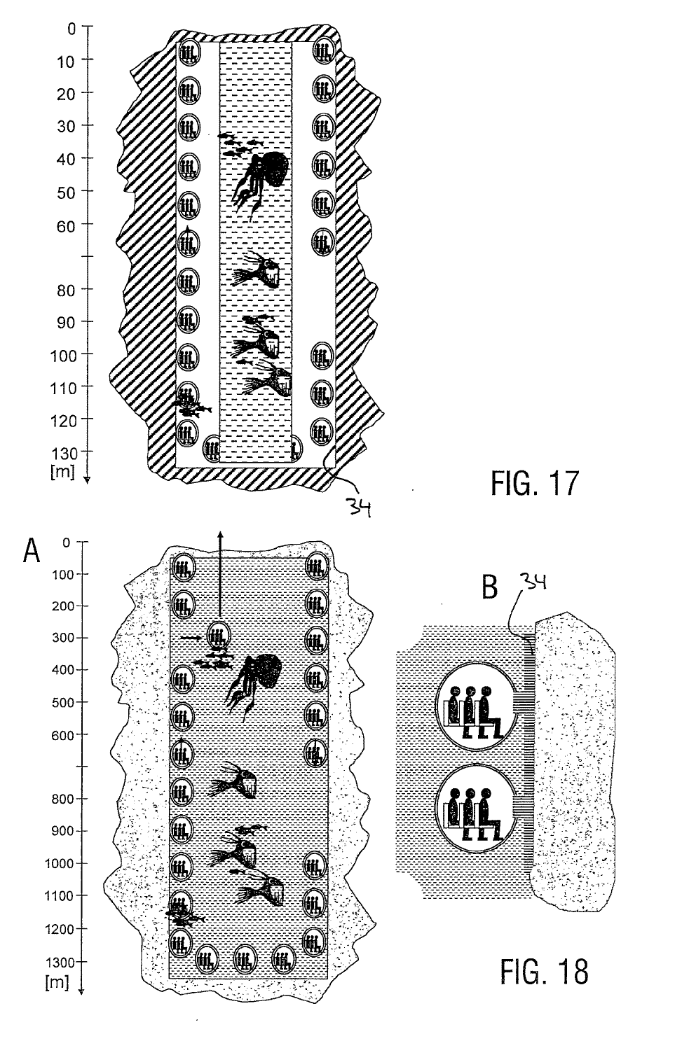

FIGS. 17 and 18 show schematic depth sectional views of further embodiments of the high-pressure device according to the invention; and

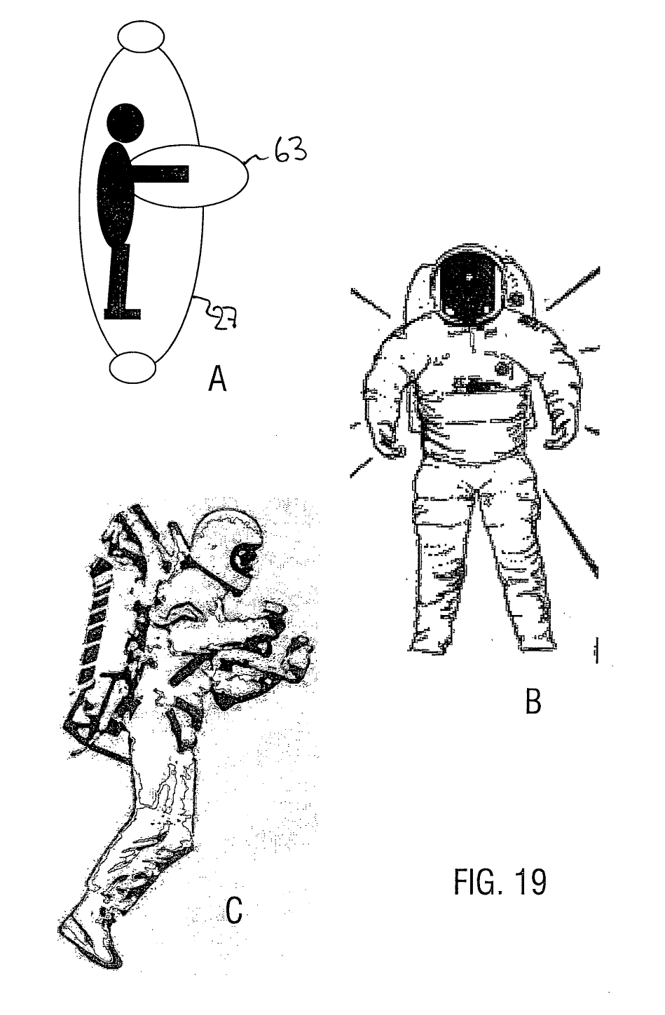

FIGS. 19A to 19C show schematic illustrations of conditions of operating personnel during operation of the high-pressure device according to the invention.

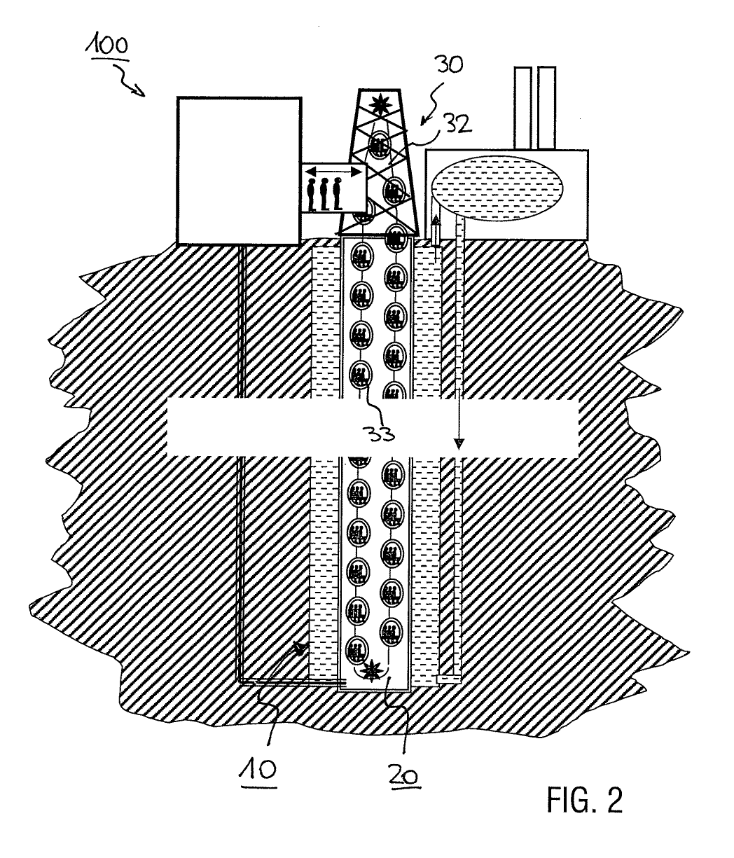

The invention will now be described using the example of a continental deep sea aquarium constructed for scientific or exhibition purposes using an existing mine shaft. The mine shaft, which extends with a longitudinal direction vertically through the earth's crust, is illustrated schematically with longitudinal (depth) sectional views and transverse sectional views, wherein the shaft is not shown to scale in its whole length, but, for example in FIGS. 1 and 2, with a gap. However, implementation of the invention is not restricted to the described forms, dimensions and uses, but can also alternatively be adapted to existing circumstances. For example, an obliquely arranged shaft can also be used.

FIG. 1 shows a first embodiment of a high-pressure device 100 according to the invention, comprising a mine shaft 10 which extends in the natural earth's crust 11 and in which a water column 12 is formed, a pressure unit 20, which is arranged in the mine shaft 10, a transport device 30 which is arranged in the pressure unit 20, a pumping unit 40 with which a fill level in the mine shaft 10 can be adjusted, and a heat-exchanger unit 50.

The pressure unit 20 comprises a shaft chamber 21 as an inner pressure chamber, the outer wall of which is formed by a pressure cylinder 22. The pressure cylinder 22 extends with the shaft chamber 21 along the length of the mine shaft 10 from the surface of the earth's crust 11 to a base 23. By means of the pressure unit 20, the mine shaft 10 is divided into a dry inner cylinder and a sea water-filled outer region. Contrary to the outer chamber, the inner cylinder remains air-filled at normal pressure or a slightly raised air pressure. Viewing and accessing the aquarium therefore takes place under almost normal conditions, such as prevail at the surface or in mines.

The shaft chamber 21 is surrounded on all sides by the water column 12. The outer wall of the pressure cylinder 22 is resistant to the exterior overpressure in the water column 12 and is made entirely or partly of transparent material (e.g. glass). The outer wall may be made, for example, from steel and comprise at least one window through which the outer space in the water column can be observed visually or with a camera, or it may be made entirely from glass. The thickness of the outer wall may be adjusted, depending on the depth in the shaft 10, to the pressure conditions in the water column, and can accordingly be smaller close to the surface than at the bottom 23. Advantageously, this achieves a saving both of weight and material in the pressure unit 20. The choice of material and the dimensions for the outer wall can be made based on experience gained from the construction of submarine vehicles for the deep sea.

The pressure unit 20 contains a schematically illustrated inner construction 60, which generally comprises one of the following assemblies. A steel ladder system with platforms for the ascent and descent of servicing personnel in emergencies, and emergency exit platforms for the transport device 30 at regular intervals, with access to the steel ladder system can be provided. Other parts of the internal construction 60 may include electrical supply lines, communication lines and/or intercom systems. Furthermore, pump systems for removing any water which finds its way in, supply lines and sample removal systems and/or sensor systems, e.g. for mechanical cylinder loads, moisture ingress or air parameter detection can also be provided. Further details of the inner construction 60, such as laboratory rooms 61 or a transport guidance system for the transport unit 30 will be described below.

By way of variation from the illustrated embodiment, the shaft chamber 21 of the pressure unit 20 may be constructed not cylindrically, but with another form, for example, a hemicylindrical or cuboid form. Furthermore, the inner pressure chamber may be partially surrounded by the water column 12 and partially by a wall of the shaft, i.e. by solid rock.

The pressure unit 20 also comprises an outer construction which generally comprises at least one of the following assemblies:
water feed and removal conduits for regeneration of the water, oxygen and gas import, for adjusting the salt content and the temperature, etc.,
sample removal systems,
pressure transfer chamber systems for introducing organisms at any depth in the shaft,
temperature and other sensor systems for detecting the water conditions,
feeding systems for the organisms,
elements for preventing or promoting convection of warm water and sedimentation of cold water,
insertable platforms at various heights to prevent sedimentation or the unwanted ascent of organisms,
local heating or cooling systems, for example, to generate “hot smokers” or methane hydrates, etc.,
illumination systems where these cannot be accommodated in the inner cylinder, and/or
catching systems (nets, capsules, hooks) for introduction from above into the water cylinder.

The transport unit 30 comprises a lift 31 with which the transported items, for example, persons, samples and/or equipment can be transported in the shaft 10. The lift 31 is preferably constructed as in a conventional mine with transport cabins 31.1, a tower 31.2 and an accessway 31.3 for entry and exit. The tower 31.2 above the shaft serves to move and uncouple the cabins and for the coupling on of rescue systems, etc.

The transport unit 30 can alternatively or additionally be a gondola system (see, for example, FIG. 2) or a circulating (paternoster) lift. In order to increase safety, an emergency lift system can be provided which runs in a separate pressure-protected cylinder (see, for example, FIG. 15), so that this emergency system would not be affected by water ingress.

The pump unit 40 comprises, for example, a pump system 41 which is connected via a pipeline 42 to the foot of the water column 12, for liquid transport and/or to the base 23 of the shaft 10 for gas transport (for ventilation or for air supply or removal in the cylinder interior). Pump systems 41 for safe operation in deep shafts are known from mining technology.

The heat-exchanger unit 50 serves to control the temperature of the water in the water column 12, for acclimatising and/or for energy extraction. For heat-exchange between the shaft 10 and the surface of the earth's crust, a pipeline 51 is provided. Preferably, the heat-exchanger unit 50 comprises a geothermal energy plant, as known from energy production technology. The extracted energy can be used in the overall construction of the continental deep sea aquarium.

Further details of the method for production of the high-pressure device 100 according to FIG. 1 and its operation will now be described. The high-pressure device 100 is constructed using an existing mine shaft 10. In typical coal mines, the main shaft has a diameter of, for example, approximately 8 m to 10 m. The inner pressure cylinder 22 has a diameter, for example, of approximately 5 m.

If required, when a shaft is prepared, initially the wall of the mine shaft 10 is consolidated and covered with a surface suitable for organisms (e.g. concrete, plastics, in particular polymers, vitreous material or the like). Caverns, depressions, shaft accessways and drifts can remain, so that a widely branched water system is formed after flooding (see FIG. 10).

Since the temperature increases with depth by approximately 3° C. per 100 m, at a depth of 1000 m, a temperature of approximately 20° C. to 30° C. can be expected. This can either be used directly, similarly to geologically active sea bed regions, for heat-adapted organisms or alternatively, by cooling particular regions of the water column 12, to simulate cool deep sea regions. The wall surface of the shaft can be coated with a material which has a thermal conductivity selected to provide thermal insulation of the water column 12.

In the prepared shaft 10, the pressure-resistant cylinder system of the pressure unit 20 is installed in the dry condition. Preferably, the dry and accessible pressure cylinder 22 is assembled from hollow segments (see FIG. 9). In addition, a lift 31 is installed in the pressure cylinder 22, extending in air over the whole depth of the shaft 10 or, with interchanges, over parts of the shaft depth.

When the installation has been carried out and, in particular, the pressure cylinder 22 has been mounted in sealed manner as far as the earth's surface and the technical installations have been completed, the shaft 10 can be flooded. For this purpose, existing ground water is introduced into the shaft 10 by specific pumping-in or by switching off previous pumping-out. As a result, a water column of, for example, 1000, 2000 or more metres is made available.

The properties of the water, and in particular its chemical composition (e.g. the salt content and nutrient content) and its temperature can then be corrected or adjusted if needed. Producing stable conditions may take months or possibly even years. In particular, regulation of the addition of nutrients can be provided in order to ensure the growth of deep sea organisms, even with large populations.

For operation of the high-pressure device 100, organisms can be established at different depths in the flooded shaft 10. For this purpose, suitable platforms, attachment sites, caverns, etc. can be provided in the wall of the shaft 10. The organisms can be lowered into the shaft from above or introduced from the pressure unit 20 into the water column 12 through a transfer chamber.

On further operation of the high-pressure device 100, cleaning of the outer glass surface of the pressure cylinder 22 may possibly be provided. By means of the cleaning, for example, bacterial growth (biofilm formation) or growth of algae arising as a result of the invasion of photosynthetically active organisms due to illumination for observation purposes can be removed.

FIG. 2 shows a further embodiment of the high-pressure device 100 according to the invention with the mine shaft 10, the pressure unit 20 and the transport unit 30 which, in this case, comprises a gondola lift 32. The gondola lift 32 comprises a plurality of, for example, round or cylindrical gondolas 33. The diameter of a gondola is, for example, approximately 1.5 m to 2 m. There is space in a gondola 33, for example, for between 2 and 6 persons. The gondolas 33 can be equipped with seats.

The gondola lift 32 enables a large number of visitors to be transported in the pressure unit 20 through the deep sea aquarium. The gondola lift 32 operates on the paternoster principle and preferably constructed similarly to a mountain cable car lift. In a single passage, for example, with a depth of the shaft 10 of 1000 m, between 100 and 200 gondolas 33 could transport between 400 and 800 persons through the shaft 10 in 1 to 2 hours. This enables the commercial use of the deep sea aquarium for tourist purposes so that the maintenance-intensive plant could be operated economically and, given intensive public operation, even profitably.

The gondolas 33 can be linked to the surface by means of a communications system and have emergency lighting. It is possible to evacuate the gondolas 33 via a secure emergency exit towards an emergency staircase. Apart from being fastened to the cable, the gondolas 33 can run in a guidance device (guide rail) 34 (see FIGS. 17B, 18B), in which the gondolas can be braked in the event that the main and safety cables break. Standstill of the transport mechanism, power failure, breakage of the cable, etc., do not therefore present any mortal danger, even though the gondolas run in a shaft which is 1000 m or more deep.

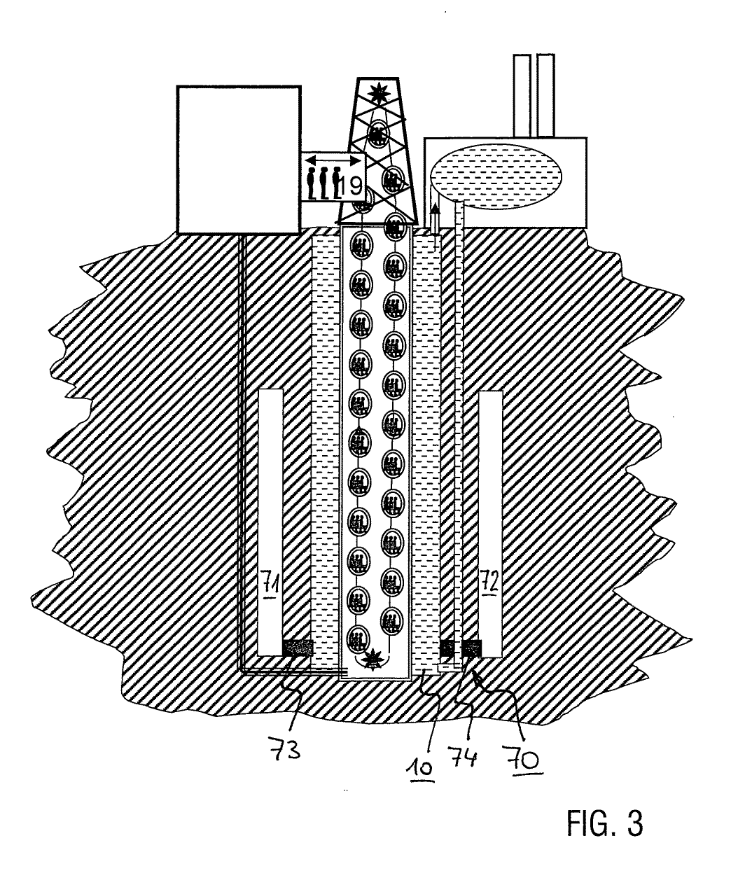

A serious problem during operation of the aquarium would be the unintended ingress of a large volume of water into the shaft 10, for example, due to the bursting of a hollow segment of the pressure cylinder. For this event, powerful pumps can be provided which keep the shaft chamber dry long enough for the persons situated therein to be evacuated. If a whole mine is not used as an aquarium part, the cylindrical water column can be pumped out relatively rapidly with high-powered pumps, although with the loss of the organisms. The additional pressure-resistant rescue lifts with separate air supply also allow the evacuation of a few persons (e.g. in the event of an accident in a purely scientific laboratory with few personnel). By means of these measures, the continental deep sea aquarium can be made far safer than a laboratory in the open sea. However, a separate protection unit 70, as illustrated schematically in FIG. 3, is preferably provided.

According to the embodiment of the invention shown in FIG. 3, the protection unit 70 comprises two auxiliary shafts 71, 72 for accommodating water from the shaft 10. The auxiliary shafts 71, 72 are connected via two flood gates 73, 74 to the floor 23 of the shaft 10. In the event of an accident, the flood gates 73, 74 are opened (for example, by an explosion), so that water can run out of the shaft 10 into the auxiliary shafts 71, 72, until the same level is reached in all the shafts. As soon as water flows into the auxiliary shafts 71, 72, an abrupt pressure release takes place in the shaft 10.

FIGS. 4A and 4B show a more detailed representation of the shaft system with a water-filled outer chamber (water column 12) with marine animals 1 from the different depths. FIG. 4A shows the shaft 10 with a diameter of approximately 8 m, as is typical for mines. The pressure unit 20 is arranged eccentrically in the shaft 10. The suspension of the gondolas 33 is shown in FIG. 4B. In order to fasten the gondolas 33, a main cable 35 and a holding cable 36 are used, as is known from conventional cable car lifts. Preferably, a rotatable hanging 37 of the gondolas 33 is provided. FIG. 5 shows the corresponding cross-section through the shaft 10 and the pressure unit 20 with the gondolas 33, further supply lines and, possibly an emergency lift.

FIG. 6 shows further details of the internal construction 60 of the pressure unit 20 in the shaft 10. Apart from the transport unit 30 with the gondolas 33, rooms 61 for the accommodation of persons and a staircase 62 are provided. The staircase 62 comprises, for example, an emergency staircase with platforms and accessways to the rooms 61. Furthermore, lines 64, for example, cables, signal lines and pressure lines are arranged at the side. Supply shafts 65 serve in the supply of air and water or to accommodate an emergency lift system for rapid conveying of emergency personnel or for evacuation. Furthermore, the internal construction 60 comprises rod-shaped or beam-shaped support elements 66, by means of which the pressure cylinder 22 is stiffened.

The animal and plant world in the water column 12 can be observed from the gondolas 33. For this purpose, the pressure cylinder is transparent at least in the viewing direction. The gondolas 33 run on guide rails 34 (middle) and hanging on a cable, upwardly on one side and downwardly on the other side.

FIG. 7 shows, in a schematic depth section, the arrangement of the stairs 62, the supply shaft 65 with the emergency lift system, and the transport unit 30 with the gondolas 33. Suitably, the pressure cylinder 22 is assembled from hollow segments 24 (see FIG. 9), wherein each installation shown in FIG. 7 is provided in one respective hollow segment 24. In the vertical direction of the aquarium, the hollow segments 24 can be differently designed, for example, with rooms 61 for accommodating persons.

FIG. 8 shows the deepest region (deep sea region) of the continental deep sea aquarium. The outer water region (water column 12) can extend beneath the base 23 and branch into drifts 13 and other depressions such as occur in mines. This causes the creation of biotopes which resemble natural conditions. FIG. 8 also shows that the gondolas 33 can each be equipped with illumination elements 38 (e.g. floodlights). The illumination elements 38 are configured such that only those areas are illuminated which can be observed by persons in the gondolas 33. Alternatively or additionally, illumination elements 38 can be provided on the outside of the pressure cylinder 22, as shown schematically in FIG. 9.

Preferably, the pressure cylinder 22 of the high-pressure device 100 is assembled from a stack of hollow segments 24, as illustrated schematically in FIG. 9. The hollow segments 24 are anchored with wall anchors 25 in one or more walls of the shaft 10 (see also FIG. 16). Either a rigid or an elastic anchor can be provided. Accordingly, the wall anchors 25 consist of a solid, rigid material or a flexible material. A damped or elastic wall coupling can be advantageous in order to compensate for possible vibrations or rock movements in the region of the shaft. In addition to the wall anchors 25, for strain relief on the pressure cylinder 22, tensioning elements, for example, tensioning cables can be provided.

In the axial direction, the hollow segments 24 have profiled edges which complement one another and which, in the assembled condition of the hollow segments 24, engage in one another. The joints between the hollow segments 24 are sealed against the outer chamber. For example, a ring seal 26 made from an elastically deformable material is provided. Advantageously, the ring seal 26 is made water-tight by the outer water pressure, wherein the sealing effect increases accordingly with increasing depth.

The hollow segments 24 are stiffened internally for stability against the lateral pressure by means of the installed parts (in particular, the stairs (made, for example, from steel), cross-beams and transverse beams), which are also shown in FIG. 7.

According to the invention, the high-pressure device 100 according to FIG. 10 can comprise a branched system of shafts 12, 14 and drifts 13 in which deep sea organisms can reside. In the branched system, there can be regions which are visible and those which are invisible from the pressure cylinder 22.

Advantageously, undisturbed retreat regions are thereby created for the organisms. The shaft 14 is a blind shaft which, as a salt water-filled shaft in the earth's crust, represents an independent object of the invention. The branched system can be visited with autonomous unmanned or manned gondolas 33.1 (submersibles) having their own drive, for example, for observation purposes or to search for, move, remove or place animals or plants. The blind shaft 14 can be fully autonomous or can be connected, for supply purposes, with the pressure unit 20 in the main shaft 10.

FIGS. 11A to 11C show three variants of the arrangement of the pressure unit 20 and the transport unit 30 in the shaft 10 for provision of the deep sea aquarium according to the invention. In FIG. 11A, the form of a pressure-resistant accessible pressure cylinder 22 which is surrounded by water in the shaft 10 as described above is shown in cross-section. The advantage of this variant is a wide panoramic view into the aquarium with a large water volume.

In FIG. 11B, however, the pressure unit 20 is a hollow cylinder in which the water column 12 is arranged. The pressure unit 20 surrounds the water column 12 on all sides. In this variant, the water volume can advantageously be reduced to the thickness of a tubular glass conduit, which enables a high degree of safety in the aquarium. A typical diameter of the aquarium cylinder is, for example, in the range of 1 m to 3 m. Alternatively, a plurality of water columns can be installed adjacent to one another. Advantageously, organisms, for example, predators can thereby be separated from their prey.

According to FIG. 11C, the whole of the shaft 10 is filled with a large volume of water. In this embodiment of the invention, the pressure unit 20 and the transport unit 30 form a common structure. The individual gondolas 33 are pressure-resistant and are supplied autonomously, or via a supply line, with energy and breathing air.

An essential element of an accessible deep sea aquarium is the safety technology. In particular, in the event of water ingress in the visitor/working area of the pressure unit 20, a water column of several hundred metres would present a great hazard. The greatest risk for persons in the pressure unit 20 occurs in the variants shown in FIGS. 11A and 11C since in these cases, substantial quantities of water must be dealt with.

As an alternative to the embodiment shown in FIG. 3, the high-pressure device 100 according to the invention can be equipped, for accident prevention, with protection units 70, as shown schematically in FIGS. 12 and 13.

According to FIG. 12, the protection unit 70 has an auxiliary shaft 71 which extends as a shaft extension beneath the floor 23 of the pressure cylinder 22 a greater depth (e.g. a few hundred metres or less) into the earth's crust. The dimension (depth and/or diameter) of the auxiliary shaft 71 is chosen so that its volume V2 can accommodate the volume V1 of the water column 12. Provided between the shaft 10 and the auxiliary shaft 71 is a bulkhead wall 75, which can be opened abruptly for abrupt release of the pressure on the air-filled pressure cylinder 22, so that the quantity of water able to enter is greatly reduced. If, for example, the bulkhead wall 75 were opened by an explosion, the water column 12 would fall into the depths. As a result, the lateral pressure on the pressure cylinder 22 would fall to almost zero.

According to FIG. 13, the protection unit 70 has two additional shafts 71, 72 which extend as shaft extensions beneath the shaft 10 into the earth's crust. This variant is preferred on use of a high pressure device according to FIG. 11B with a water-filled inner cylinder. Due to the relatively small volume of water V1 shorter shaft extensions from the base suffice as auxiliary shafts 71, 72. Pump sumps, from which the water can be removed, can be provided in the auxiliary shafts 71, 72. The receiving capacity V2 may be smaller than the water volume V1. Furthermore, side galleries or auxiliary shafts can be used for receiving the water.

FIG. 14 shows a section of a shaft chamber 21 in the deep sea aquarium. A docking system, for example, in the form of a transfer chamber 63 is provided in the shaft chamber 21 for removing and introducing organisms to or from the water column 12. The transfer chamber 63 comprises, for example, a pressure aquarium which is built into the wall of the pressure cylinder 22 and is connected to a pressure control system 67 (for example, with a hydraulic pump). For receiving a fish 2 from the outer region, the pressure in the pressure aquarium is increased to the depth pressure of the water column 12. Then the fish 2 is received via an open transfer chamber door. In corresponding manner, organisms or other samples can be removed or introduced.

FIG. 15 shows an embodiment of the invention wherein a plurality of pressure units 20.1 to 20.4 and a plurality of water columns 12.1 to 12.9 are arranged in the shaft 10. Each of the water columns is arranged in a separate longitudinal shaft compartment extending over the length of the shaft. This embodiment is advantageous both for scientific (investigation of different systems that cannot be mutually tolerated) purposes and for touristic purposes. Due to the arrangement of shaft compartments of small diameter and correspondingly formed visitor gondolas in the dry region, the illusion of a deep sea journey can be created.

A derived embodiment of the invention wherein the tubular pressure unit 20 is anchored segment by segment on all sides to the shaft wall is shown in FIG. 16. To relieve the strain due to the intrinsic mass of the structure, the hollow segments 24 hang from the wall, with the result that the stability of the pressure cylinder 22 is significantly increased.

FIG. 17 illustrates an embodiment of the invention wherein the transport unit 30 comprises rail-bound gondolas (with a construction similar to FIG. 11B) which circulate along the wall of the shaft 10. This construction enables branches to be installed, with points and detours, so that individual gondolas can be introduced and removed.

According to FIG. 18, the pressure unit 20 comprises a plurality of pressure-resistant pressure capsules 27 which are moved on rails or other guiding means in the shaft wall. Alternatively, a free cable drive or a combination of cable and rail drive can be provided. In the latter case, a single pressure capsule can be lowered into the water column 12 on the cable and docked onto the guiding means at a suitable site (see arrow).

The pressure capsules 27 can be configured for accommodating a single person. In addition, a pressure capsule 27 can be equipped with a transfer chamber 63 (FIG. 19A). Particular depth regions, in particular less than 500 m can be visited in diving suits, which are illustrated schematically in FIGS. 19B and 19C.

The features of the invention disclosed in the above description, the drawings and the claims can be significant, both individually and in combination, to the realisation of the invention in its different embodiments.

1. A high-pressure device, comprising:
a shaft which extends into the earth's crust, and
a pressure unit, which is arranged in the shaft and comprises an inner pressure chamber which is resistant to an exterior overpressure.

2. The high-pressure device according to claim 1, wherein at least one water column is arranged in the shaft.

3. The high-pressure device according to claim 1, wherein the shaft is a mine shaft.

4. The high-pressure device according to claim 1, wherein a transport unit is provided, with which transported items can be transported in the shaft.

5. The high-pressure device according to claim 4, wherein the transport unit is arranged in the pressure unit.

6. The high-pressure device according to claim 4, wherein the transport unit is arranged in the shaft outside the pressure unit.

7. The high-pressure device according to claim 4, wherein the transport unit comprises a lift.

8. The high-pressure device according to claim 1, wherein a pump unit is provided, with which a fill level in the shaft can be adjusted.

9. The high-pressure device according to claim 1, wherein a heat-exchanger unit is provided, with which heat exchange can be carried out between the shaft and a surface of the earth's crust.

10. The high-pressure device according to claim 1, wherein an internal construction is provided in the pressure unit.

11. The high-pressure device according to claim 10, wherein the internal construction comprises at least one of the assemblies including a room for accommodating persons, at least one staircase and at least one transfer chamber.

12. The high-pressure device according to claim 1, wherein a protection unit is provided, with which a hydrostatic pressure in the shaft can be abruptly reduced.

13. The high-pressure device according to claim 12, wherein the protection unit comprises at least one auxiliary shaft for accommodating water from the shaft.

14. The high-pressure device according to claim 1, wherein the pressure unit comprises at least one of the assemblies including at least one shaft chamber and at least one pressure capsule.

15. The high-pressure device according to claim 14, wherein the at least one shaft chamber extends along the length of the shaft.

16. The high-pressure device according to claim 14, wherein the at least one shaft chamber has a cylindrical form.

17. The high-pressure device according to claim 14 wherein the at least one shaft chamber is assembled from a stack of hollow segments.

18. The high-pressure device according to claim 17, wherein the hollow segments are anchored into a wall of the shaft with wall anchors.

19. The high-pressure device according to at least one of the claim 14, wherein the at least one shaft chamber is surrounded by the at least one water column.

20. The high-pressure device according to at least one of the claim 14, wherein the at least one water column is surrounded by the at least one shaft chamber.

21. The high-pressure device according to claim 14, wherein the at least one shaft chamber at least partially comprises a transparent material.

22. A method for production of a high-pressure device according to claim 1 comprising the steps:
provision of the shaft in the earth's crust in an empty condition,
provision of the pressure unit in the shaft, and
introduction of water into the shaft, so that at least one water column is formed outside the pressure unit.

23. The method according to claim 22, wherein the provision of the pressure unit comprises assembly of a stack of hollow segments in the shaft.

24. A method for operating a high-pressure device which has a shaft in the earth's crust and which has at least one water column, comprising the step:
cultivation of organisms in the at least one water column.

25. The method according to claim 24, comprising the step:
observation of the organisms in the at least one water column.

26. The method according to claim 25, wherein the observation of the organisms comprises a visual observation from a pressure unit which is arranged in the shaft and has an inner pressure chamber which is resistant to an exterior overpressure.

27. The method according to claim 24, further comprising the step:
transport of transported items in the shaft.

28. The method according to claim 24, further comprising the step:
energy conversion using a heat-exchanger unit which is arranged on a surface of the earth's crust.

29. The method according to claim 24, further comprising the step:
pressure relief in the shaft by actuating a protection unit.

30. The method according to claim 29, wherein the pressure relief comprises flowing away of the water into at least one auxiliary shaft.

31. A high-pressure shaft in the earth's crust, which contains at least one water column comprising salt water.

32. The high-pressure shaft according to claim 31, wherein the water column has a salt content which is greater than 20%.

33. The high-pressure shaft according to claim 31, wherein the water column is formed by sea water.
